(19) United States
(12) Patent Application Publication
(10) Pub. No.: US 2014/0120179 A1
(43) Pub. Date: May 1, 2014

(54) STABILIZATION OF PEROXYCARBOXYLIC ACIDS USING AMINE ACID SALTS

(71) Applicants: Kim R. Smith, Woodbury, MN (US); Erik C. Olson, Savage, MN (US); Benjamin F. Reid, Medina, MN (US)

(72) Inventors: Kim R. Smith, Woodbury, MN (US); Erik C. Olson, Savage, MN (US); Benjamin F. Reid, Medina, MN (US)

(21) Appl. No.: 13/661,235

(22) Filed: Oct. 26, 2012

(51) Int. Cl. A01N 59/00; A01P 1/00

(52) U.S. Cl. 424/616

(57) ABSTRACT

Peroxycarboxylic acid compositions and methods of using the same are provided to enhance stability and increase shelf-life over conventional peracid compositions. Peroxycarboxylic acid compositions are formulated or treated with amine salts of acetic acid and/or sulfuric acid, ammonium salts, sodium salts of acetic acid and/or sulfuric acid, polymeric amines and/or other stabilizing agents according to the invention. The invention further relates to methods employing such compositions, and methods of making these compositions.

### FIELD OF THE INVENTION

The invention relates to the field of stabilized peroxycarboxylic acid compositions and methods of using the same. In particular, the invention relates to peroxycarboxylic acid compositions having improved shelf stability through the stabilization of both hydrogen peroxide and peroxycarboxylic acids, representing an improvement over traditional chelants and/or sequestrants traditionally used for stability. Stabilizer additives suitable for peroxycarboxylic acid compositions according to the invention are preferably ammonium salts, polymeric amines, and the amine salts and/or sodium salts of acetic acid and/or sulfuric acid.

### BACKGROUND OF THE INVENTION

Peracid compositions, namely peroxycarboxylic acid compositions, exhibit useful antimicrobial and bleaching activity. Conventional peroxycarboxylic acid compositions typically include short chain peroxycarboxylic acids or mixtures of short chain peroxycarboxylic acids and medium chain peroxycarboxylic acids, such as those disclosed in U.S. Pat. Nos. 5,200,189, 5,314,687, 5,409,713, 5,437,868, 5,489,434, 6,674,538, 6,010,729, 6,111,963, and 6,514,556, each of which is incorporated by reference in its entirety. Such peroxycarboxylic acids have low molecular weights, including for example peracetic acid.

Peracid compositions, including the peroxycarboxylic acids peroxyacetic acid and peroxyoctanoic acid, have a number of inherent disadvantages, namely the malodors and relative instability which limit their use in many applications. Peracid compositions may exhibit a strong, sharp, irritating, or otherwise unacceptable odor. In addition to the odors commonly associated with peracid compositions, peracids decompose as a result of the relative instability of the compositions. In approximately one year at ambient conditions the amount of peroxycarboxylic acid in a composition can decrease by about 50% to about 80% or greater, of the initial equilibrium values or use composition levels.

Such decomposition profiles caused by peracid instability significantly limit the applications suitable for using such peroxycarboxylic acid compositions. Despite the limitations of peroxycarboxylic acid compositions, there remains a need for effective antimicrobial agents, including peroxycarboxylic acid compositions with improved stability. Accordingly, it is an objective of the claimed invention to develop peroxycarboxylic acid compositions having improved stability.

According to the invention, it is desired to produce a shelf-stable, antimicrobial peroxycarboxylic acid composition and/or methods for providing the same using non-traditional stabilizer additives.

A further object of the invention is to develop shelf-stable, antimicrobial peroxycarboxylic acid compositions using an ammonium compound, amine salt of acetic acid and/or sulfuric acid, and/or sodium salt of acetic acid and/or sulfuric acid, as a stabilizer additive for peroxycarboxylic acid compositions.

### BRIEF SUMMARY OF THE INVENTION

An advantage of the invention is the improvement of shelf-stability for peroxycarboxylic acid (also referred to herein as a “peracid”) compositions. The present invention relates to peracid compositions having significantly improved stability as demonstrated by reduced or eliminated peracid decomposition compared to conventional peracid compositions, and methods for generating and employing the enhanced stability peracid compositions. Typically, the compositions and methods according to the present invention incorporate one or more suitable non-chelating and/or non-sequestrant stabilizer additives as stabilizing agents.

In an embodiment, the present invention provides an enhanced stability peroxycarboxylic acid composition comprising: at least one peroxycarboxylic acid; hydrogen peroxide; and a stabilizing agent, wherein the stabilizing agent is a nitrogen-containing compound or a sodium salt that is effective for enhancing peroxycarboxylic acid stability and is present in a weight ratio of peroxycarboxylic acid to stabilizing agent from about 1000:1 to about 10:1. In an aspect, the stabilizing agent is an ammonium salt, polymeric amine, amine salt and/or sodium salt of acetic acid and/or sulfuric acid.

In a further embodiment, the present invention provides a stability enhanced peroxycarboxylic acid composition comprising: about 0.01 wt-% to 50 wt-% of at least one peroxycarboxylic acid selected from the group consisting of an alkyl peroxycarboxylic acid, a sulfoperoxycarboxylic acid and combinations of the same; about 0.01 wt-% to 50 wt-% of hydrogen peroxide; and about 0.00001 wt-% to 10 wt-% of a stabilizing agent, wherein the stabilizing agent is a nitrogen-containing compound or a sodium salt that is effective for enhancing peroxycarboxylic acid and hydrogen peroxide stability and is present in a weight ratio of peroxycarboxylic acid to stabilizing agent from about 1000:1 to about 10:1. In an aspect, the stabilizing agent is an ammonium salt, polymeric amine, amine salt and/or sodium salt of acetic acid and/or sulfuric acid.

In another embodiment, the present invention provides a method of reducing population of microorganism on an object, comprising: contacting an object with stability enhanced peroxycarboxylic acid composition according to the invention.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows peroxyacetic acid stability in concentrated peroxyacetic acid compositions as a result of the addition of various stabilizing agents over time.

FIG. 2 shows hydrogen peroxide stability in concentrated peroxyacetic acid compositions as a result of the addition of various stabilizing agents over time.

FIG. 3 shows peroxyacetic acid stability in concentrated peroxyacetic acid compositions as a result of the addition of ammonium salt and sodium salt stabilizing agents over time.

FIG. 4 shows hydrogen peroxide stability in concentrated peroxyacetic acid compositions as a result of the addition of ammonium salt and sodium salt stabilizing agents over time.

FIG. 5 shows peroxyacetic acid stability in concentrated peroxyacetic acid compositions as a result of the addition of varying concentrations of ammonium sulfate stabilizing agents over time.

FIG. 6 shows hydrogen peroxide stability in concentrated peroxyacetic acid compositions as a result of the addition of varying concentrations of ammonium sulfate stabilizing agents over time.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The present invention relates to antimicrobial and/or bleaching or compositions including a stabilizing agent, such as an ammonium compound, a polymeric amine, an amine salt and/or a sodium salt of acetic acid and/or sulfuric acid, to minimize or eliminate peracid decomposition in a peroxycarboxylic acid composition. Beneficially, the compositions of the invention have reduced odor in comparison to a peracid composition lacking the stabilizing. The compositions can be used on a variety of hard surfaces and methods of employing the same are provided within the scope of the invention.

The embodiments of this invention are not limited to particular stabilized peroxycarboxylic acid compositions and methods of generating and employing the same, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers defining the range and include each integer within the defined range.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, “agricultural” or “veterinary” objects or surfaces include animal feeds, animal watering stations and enclosures, animal quarters, animal veterinarian clinics (e.g. surgical or treatment areas), animal surgical areas, and the like.

As used herein, the phrase “air streams” includes food anti-spoilage air circulation systems. Air streams also include air streams typically encountered in hospital, surgical, infirmity, birthing, mortuary, and clinical diagnosis rooms.

The term “alkyl” or “alkyl groups,” as used herein, refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can affect two kinds of microbial cell damage. The first is a lethal, irreversible action resulting in complete microbial cell destruction or incapacitation. The second type of cell damage is reversible, such that if the organism is rendered free of the agent, it can again multiply. The former is termed bacteriocidal and the later, bacteriostatic. A sanitizer and a disinfectant are, by definition, agents which provide antibacterial or bacteriocidal activity. In contrast, a preservative is generally described as an inhibitor or bacteriostatic composition.

For the purpose of this patent application, successful bacteriocidal reduction of microorganisms is achieved when the populations of microorganisms are reduced by about 50%, by significantly more than is achieved by a wash with water, or at least about 0.3-1 log₁₀. Larger reductions in microbial population provide greater levels of protection. In this application, such a population reduction is the minimum acceptable for the processes. Any increased reduction in population of microorganisms is an added benefit that provides higher levels of protection.

The term “disinfectant,” as used herein, refers to an agent that kills most vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). As used herein, the term “high level disinfection” or “high level disinfectant” refers to a compound or composition that kills substantially all organisms, except high levels of bacterial spores, and is effected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

The phrase “food processing surface” or “food surface,” as used herein, refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, sanitizing gels, cooling towers, food processing antimicrobial garment sprays, and non-to-low-aqueous food preparation lubricants, oils, and rinse additives.

The phrase “health care surface,” as used herein, refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.), or woven and non-woven surfaces (such as surgical garments, draperies, bed linens, bandages, etc.), or patient-care equipment (such as respirators, diagnostic equipment, shunts, body scopes, wheel chairs, beds, etc.), or surgical and diagnostic equipment. Health care surfaces include articles and surfaces employed in animal health care.

The term “heterocyclic group,” as used herein (e.g. referring to substituted alkyls including a heterocyclic group), includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The term “instrument,” as used herein, refers to the various medical or dental instruments or devices that can benefit from cleaning with a reduced-odor composition according to the present invention. The phrases “medical instrument”, “dental instrument”, “medical device”, “dental device”, “medical equipment”, or “dental equipment” refer to instruments, devices, tools, appliances, apparatus, and equipment used in medicine or dentistry. Such instruments, devices, and equipment can be cold sterilized, soaked or washed and then heat sterilized, or otherwise benefit from cleaning in a composition of the present invention. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, arthoscopes and related equipment, and the like, or combinations thereof.

The term “microorganisms,” as used herein, refers to any noncellular or unicellular (including colonial) organism. Microorganisms include all prokaryotes. Microorganisms include bacteria (including cyanobacteria), lichens, microfungi, protozoa, virinos, viroids, viruses, and some algae. As used herein, the term “microbe” is synonymous with microorganism.

The phrases “objectionable odor,” “offensive odor,” or “malodor,” as used herein, refer to a sharp, pungent, or acrid odor or atmospheric environment from which a typical person withdraws if they are able to. Hedonic tone provides a measure of the degree to which an odor is pleasant or unpleasant. An “objectionable odor,” “offensive odor,” or “malodor” has an hedonic tone rating it as unpleasant as or more unpleasant than a solution of 5 wt-% acetic acid, propionic acid, butyric acid, or mixtures thereof.

The term “object”, as used herein, refers to a something material that can be perceived by the senses, directly and/or indirectly. Objects include a surface, including a hard surface (such as glass, ceramics, metal, natural and synthetic rock, wood, and polymeric), an elastomer or plastic, woven and non-woven substrates, a food processing surface, a health care surface, and the like. Objects also include a food product (and its surfaces); a body or stream of water or a gas (e.g., an air stream); and surfaces and articles employed in hospitality and industrial sectors.

As used herein, the term “phosphorus-free” or “substantially phosphorus-free” refers to a composition, mixture, or ingredient that does not contain phosphorus or a phosphorus-containing compound or to which phosphorus or a phosphorus-containing compound has not been added. For “phosphorus-free compositions,” the minimal amount of phosphorus or a phosphorus-containing compound should be present only through contamination of a phosphorus-free composition, mixture, or ingredients, and the amount of phosphorus shall be less than 0.5 wt-%. More preferably, the amount of phosphorus is less than 0.1 wt-%, and most preferably the amount of phosphorus is less than 0.01 wt-%.

The term “sanitizer,” as used herein, refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25° C.+/−2° C., against several test organisms.

The phrase “short chain carboxylic acid,” as used herein, refers to a carboxylic acid that has characteristic bad, pungent, or acrid odor. Examples of short chain carboxylic acids include formic acid, acetic acid, propionic acid, and butyric acid.

The term “sporicide,” as used herein, refers to a physical or chemical agent or process having the ability to cause greater than a 90% reduction (1-log order reduction) in the population of spores, such as spores of Bacillus cereus or Bacillus subtilis, within 30 minutes at ambient temperature. In certain embodiments, the sporicidal compositions of the invention provide greater than a 99% reduction (2-log order reduction), greater than a 99.99% reduction (4-log order reduction), or greater than a 99.999% reduction (5-log order reduction) in such population within at least 30 minutes at ambient temperature.

The terms “vehicle” or “car” as used herein, refer to any transportation conveyance including without limitation, automobiles, trucks, sport utility vehicles, buses, trucks, motorcycles, monorails, diesel locomotives, passenger coaches, small single engine private airplanes, corporate jet aircraft, commercial airline equipment, etc.

The term “ware,” as used herein, refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the invention include but are not limited to, those that include polycarbonate polymers (PC), acrilonitrile-butadiene-styrene polymers (ABS), and polysulfone polymers (PS). Another exemplary plastic that can be cleaned using the compounds and compositions of the invention include polyethylene terephthalate (PET).

As used herein, the term “waters” includes food process or transport waters. Food process or transport waters include produce transport waters (e.g., as found in flumes, pipe transports, cutters, slicers, blanchers, retort systems, washers, and the like), belt sprays for food transport lines, boot and hand-wash dip-pans, third-sink rinse waters, and the like. Waters also include domestic and recreational waters such as pools, spas, recreational flumes and water slides, fountains, and the like.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions of the present invention may comprise, consist essentially of, or consist of the components and ingredients of the present invention as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Compositions

Peroxycarboxylic acid compositions having enhanced stability are provided according to the present invention. Beneficially, the peracids to be treated according to the invention include both concentrated and ready-to-use peracid compositions. In an aspect, the peroxycarboxylic acid compositions having enhanced stability may comprise, consist of or consist essentially of a peracid and a stabilizing agent. The peroxycarboxylic acid compositions may further include one or more of the components selected from the group consisting of a surfactant, water, carboxylic acids, oxidizing agents in addition to hydrogen peroxide, chelants, sequestrants and the like. In an optional embodiment, the peroxycarboxylic acid compositions do not include chelants and/or sequestrants. In an additional aspect, the peroxycarboxylic acid compositions may further include additional functional ingredients.

While an understanding of the mechanism is not necessary to practice the present invention and while the present invention is not limited to any particular mechanism of action, it is contemplated that, in some embodiments, the peroxycarboxylic acid compositions incorporate a stabilizing agent to improve the stability and shelf-life of the peroxycarboxylic acid compositions by stabilizing at least one of an oxidizing agent (e.g. hydrogen peroxide) and/or the peroxycarboxylic acid. In an aspect of the invention the stabilizing agent changes the equilibrium of the products in the composition resulting in excess oxidizing agents (e.g. hydrogen peroxide) to stabilize and prevent the decomposition of the peracids. Unlike metal chelants and/or sequestrants that act to sequester contaminants that might otherwise facilitate decomposition of the hydrogen peroxide, the stabilizing agents of the present invention, such as for example an amine salt and/or a sodium salt of acetic acid and/or sulfuric acid, provide more significant improvements in stability and shelf-life by preferably stabilizing dual components of the compositions.

In certain aspects of the invention, the stabilizing agents are combined with conventional metal chelants and/or sequestrants to provide still further improvements in stabilization of the peracid compositions. In certain aspects, the stabilizing agents of the present invention are employed in peracid compositions using organophosphonate chelants and/or other chelants providing additional unexpected stabilization benefits.

Peracids

A variety of peroxycarboxylic acids may be employed in the compositions according to the invention. In some embodiments of the invention at least one peroxycarboxylic acid is employed. According to an embodiment of the invention suitable peroxycarboxylic acids include ester peroxycarboxylic acids, alkyl ester peroxycarboxylic acids, sulfoperoxycarboxylic acids, and combinations of several different peroxycarboxylic acids, as described herein. Further description of suitable alkyl ester peroxycarboxylic acids and ester peroxycarboxylic acids according to the invention is included in U.S. Pat. Nos. 7,816,555 and 7,622,606, both entitled “Peroxycarboxylic Acid Compositions with Reduced Odor,” hereby expressly incorporated herein in its entirety by reference, including without limitation all drawings and chemical structures contained therein.

The terms “peracid,” “peroxyacid,” “percarboxylic acid” and “peroxycarboxylic acid” as used herein, refer synonymously to acids having the general formula R(CO₃H)ₙ. The R group can be saturated or unsaturated as well as substituted or unsubstituted. As described herein, R is an alkyl, arylalkyl, cycloalkyl, aromatic, heterocyclic, or ester group, such as an alkyl ester group. N is one, two, or three, and named by prefixing the parent acid with peroxy. Ester groups are defined as R groups including organic moieties (such as those listed above for R) and ester moieties. Exemplary ester groups include aliphatic ester groups, such as R₁OC(O)R₂, where each of R₁ and R₂ can be aliphatic, preferably alkyl, groups described above for R. Preferably R₁ and R₂ are each independently small alkyl groups, such as alkyl groups with 1 to 5 carbon atoms. As one skilled in the art shall appreciate, peroxycarboxylic acids are not as stable as carboxylic acids, their stability generally increases with increasing molecular weight. Thermal decomposition of these acids can generally proceed by free radical and nonradical paths, by photodecomposition or radical-induced decomposition, or by the action of metal ions or complexes. Percarboxylic acids can be made by the direct, acid catalyzed equilibrium action of hydrogen peroxide with the carboxylic acid, by autoxidation of aldehydes, or from acid chlorides, and hydrides, or carboxylic anhydrides with hydrogen or sodium peroxide.

Exemplary peroxycarboxylic acids useful in the compositions of the present invention include peroxyformic, peroxyacetic, peroxypropionic, peroxybutanoic, peroxypentanoic, peroxyhexanoic, peroxyheptanoic, peroxyoctanoic, peroxynonanoic, peroxydecanoic, peroxyundecanoic, peroxydodecanoic, peroxylactic, peroxycitric, peroxymaleic, peroxyascorbic, peroxyhydroxyacetic (peroxyglycolic), peroxyoxalic, peroxymalonic, peroxysuccinic, peroxyglutaric, peroxyadipic, peroxypimelic, peroxysuberic, and peroxysebacic acid, and mixtures thereof. Useful peroxycarboxylic acids also include the ester peroxycarboxylic acids described herein and compositions of the present invention including those ester peroxycarboxylic acids. Peroxy forms of carboxylic acids with more than one carboxylate moiety can have one or more of the carboxyl moieties present as peroxycarboxyl moieties. These peroxycarboxylic acids have been found to provide good antimicrobial action with good stability in aqueous mixtures. In a preferred embodiment, the composition of the invention utilizes a combination of several different peroxycarboxylic acids.

In an embodiment, the compositions of the invention utilizes a combination of several different peroxycarboxylic acids, including mixed peracid compositions. The terms “mixed” or “mixture” when used relating to “peracid composition,” “peroxycarboxylic acid composition,” “peracids” or “peroxycarboxylic acids” refer to a composition or mixture including more than one peracid, such as a peroxycarboxylic acid, such as a composition or mixture including peroxyacetic acid and peroxyoctanoic acid.

According to one embodiment, the composition includes one or more small C₂-C₄ peroxycarboxylic acids, one or more large C₈-C₁₂ peroxycarboxylic acids, one or more ester peroxycarboxylic acids, one or more alkyl ester peroxycarboxylic acids, and/or one or more mono- or di-peroxycarboxylic acid having up to 12 carbon atoms. According to a further embodiment, the peroxycarboxylic acid has from 2 to 12 carbon atoms. According to an embodiment, the peroxycarboxylic acids include peroxyacetic acid (POAA) (or peracetic acid having the formula CH₃COOOH) and/or peroxyoctanoic acid (POOA) (or peroctanoic acid having the formula, for example, of n-peroxyoctanoic acid: CH₃(CH₂)₆COOOH).

According to an additional embodiment of the invention one or more sulfoperoxycarboxylic acid may also be used in the compositions disclosed herein. As used herein, the term “sulfoperoxycarboxylic acid,” “sulfonated peracid,” or “sulfonated peroxycarboxylic acid” refers to the peroxycarboxylic acid form of a sulfonated carboxylic acid. In some embodiments, the sulfonated peracids of the present invention are mid-chain sulfonated peracids. As used herein, the term “mid-chain sulfonated peracid” refers to a peracid compound that includes a sulfonate group attached to a carbon that is at least one carbon (e.g., the three position or further) from the carbon of the percarboxylic acid group in the carbon backbone of the percarboxylic acid chain, wherein the at least one carbon is not in the terminal position. As used herein, the term “terminal position,” refers to the carbon on the carbon backbone chain of a percarboxylic acid that is furthest from the percarboxyl group.

According to an embodiment of the invention, sulfoperoxycarboxylic acids have the following general formula:

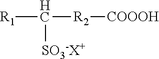

wherein R₁ is hydrogen, or a substituted or unsubstituted alkyl group; R₂ is a substituted or unsubstituted alkyl group; X is hydrogen, a cationic group, or an ester forming moiety; or salts or esters thereof.

In some embodiments, R₁ is a substituted or unsubstituted Cₘ alkyl group; X is hydrogen a cationic group, or an ester forming moiety; R₂ is a substituted or unsubstituted Cₙ alkyl group; m=1 to 10; n=1 to 10; and m+n is less than 18, or salts, esters or mixtures thereof. In some embodiments, R₁ is hydrogen. In other embodiments, R₁ is a substituted or unsubstituted alkyl group. In some embodiments, R₁ is a substituted or unsubstituted alkyl group that does not include a cyclic alkyl group. In some embodiments, R₁ is a substituted alkyl group. In some embodiments, R₁ is an unsubstituted C₁-C₉ alkyl group. In some embodiments, R₁ is an unsubstituted C₇ or C_{g} alkyl. In other embodiments, R₁ is a substituted C₈-C₁₀ alkyl group. In some embodiments, R₁ is a substituted C₈-C₁₀ alkyl group is substituted with at least 1, or at least 2 hydroxyl groups. In still yet other embodiments, R₁ is a substituted C₁-C₉ alkyl group. In some embodiments, R₁ is a substituted C₁-C₉ substituted alkyl group is substituted with at least 1SO₃H group. In other embodiments, R₁ is a C₉-C₁₀ substituted alkyl group. In some embodiments, R₁ is a substituted C₉-C₁₀ alkyl group wherein at least two of the carbons on the carbon backbone form a heterocyclic group. In some embodiments, the heterocyclic group is an epoxide group.

In further embodiments, R₂ is a substituted C₁-C₁₀ alkyl group. In some embodiments, R₂ is a substituted C₈-C₁₀ alkyl. In some embodiments, R₂ is an unsubstituted C₆-C₉ alkyl. In other embodiments, R₂ is a C₈-C₁₀ alkyl group substituted with at least one hydroxyl group. In some embodiments, R₂ is a C₁₀ alkyl group substituted with at least two hydroxyl groups. In other embodiments, R₂ is a C₈ alkyl group substituted with at least one SO₃H group. In some embodiments, R₂ is a substituted C₉ group, wherein at least two of the carbons on the carbon backbone form a heterocyclic group. In some embodiments, the heterocyclic group is an epoxide group. In some embodiments, R₁ is a C₈-C₉ substituted or unsubstituted alkyl, and R₂ is a C₇-C₈ substituted or unsubstituted alkyl.

Further description of suitable sulfoperoxycarboxylic acids, and methods of making the same, according to the invention are included in U.S. patent application Ser. Nos. 12/568,493 and 12/413,189, entitled “Sulfoperoxycarboxylic Acids, Their Preparation and Methods of Use as Bleaching and Antimicrobial Agents,” hereby expressly incorporated herein in its entirety by reference, including without limitation all drawings and chemical structures contained therein.

According to an additional embodiment of the invention one or more carboxylic acids may also be used in the compositions disclosed herein. Generally, carboxylic acids have the formula R—COOH wherein the R can represent any number of different groups including aliphatic groups, alicyclic groups, aromatic groups, heterocyclic groups, and ester groups, such as alkyl ester groups, all of which can be saturated or unsaturated and/or substituted or unsubstituted. Carboxylic acids can have one, two, three, or more carboxyl groups. Preferred ester groups include aliphatic ester groups, such as R₁OC(O)R₂— where each of R₁ and R₂ can be aliphatic, preferably alkyl, groups described above for R. Preferably R₁ and R₂ are each independently small alkyl groups, such as alkyl groups with 1 to 4 carbon atoms.

The composition of the invention can employ carboxylic acids containing as many as 22 carbon atoms. Examples of suitable carboxylic acids include formic, acetic, propionic, butanoic, pentanoic, hexanoic, heptanoic, octanoic, nonanoic, decanoic, undecanoic, dodecanoic, lactic, maleic, ascorbic, citric, hydroxyacetic (glycolic), neopentanoic, neoheptanoic, neodecanoic, oxalic, malonic, succinic, glutaric, adipic, pimelic suberic, and sebacic acid. Examples of suitable alkyl ester carboxylic acids include monomethyl oxalic acid, monomethyl malonic acid, monomethyl succinic acid, monomethyl glutaric acid, monomethyl adipic acid, monomethyl pimelic acid, monomethyl suberic acid, and monomethyl sebacic acid; monoethyl oxalic acid, monoethyl malonic acid, monoethyl succinic acid, monoethyl glutaric acid, monoethyl adipic acid, monoethyl pimelic acid, monoethyl suberic acid, and monoethyl sebacic acid; monopropyl oxalic acid, monopropyl malonic acid, monopropyl succinic acid, monopropyl glutaric acid, monopropyl adipic acid, monopropyl pimelic acid, monopropyl suberic acid, and monopropyl sebacic acid, in which propyl can be n- or isopropyl; and monobutyl oxalic acid, monobutyl malonic acid, monobutyl succinic acid, monobutyl glutaric acid, monobutyl adipic acid, monobutyl pimelic acid, monobutyl suberic acid, and monobutyl sebacic acid, in which butyl can be n-, iso-, or t-butyl.

In some embodiments, the carboxylic acid for use with the compositions of the present invention is a C₂ to C₁₂ carboxylic acid. In some embodiments, the carboxylic acid for use with the compositions of the present invention is a C₅ to C₁₁ carboxylic acid. In some embodiments, the carboxylic acid for use with the compositions of the present invention is a C₁ to C₄ carboxylic acid. Examples of suitable carboxylic acids include, but are not limited to, formic, acetic, propionic, butanoic, pentanoic, hexanoic, heptanoic, octanoic, nonanoic, decanoic, undecanoic, dodecanoic, as well as their branched isomers, lactic, maleic, ascorbic, citric, hydroxyacetic, neopentanoic, neoheptanoic, neodecanoic, oxalic, malonic, succinic, glutaric, adipic, pimelic subric acid, and mixtures thereof. Carboxylic acids that are generally useful include ester carboxylic acids, such as alkyl ester carboxylic acids.

In some embodiments, the compositions of the present invention include a combination of peroxycarboxylic acids and optionally carboxylic acids. According to an embodiment, the compositions of the present invention include at least one sulfoperoxycarboxylic acid and at least one carboxylic and/or percarboxylic acid. In some embodiments, the compositions of the present invention include at least two, at least three, or at least four or more carboxylic and/or peroxycarboxylic acids.

The chemical structures herein, including the peroxycarboxylic acids, are drawn according to the conventional standards known in the art. Thus, where an atom, such as a carbon atom, as drawn appears to have an unsatisfied valency, then that valency is assumed to be satisfied by a hydrogen atom, even though that hydrogen atom is not necessarily explicitly drawn. The structures of some of the compounds of this invention include stereogenic carbon atoms. It is to be understood that isomers arising from such asymmetry (e.g., all enantiomers and diastereomers) are included within the scope of this invention unless indicated otherwise. That is, unless otherwise stipulated, any chiral carbon center may be of either (R)- or (S)-stereochemistry. Such isomers can be obtained in substantially pure form by classical separation techniques and by stereochemically-controlled synthesis. Furthermore, alkenes can include either the E- or Z-geometry, where appropriate. In addition, the compounds of the present invention may exist in unsolvated as well as solvated forms with acceptable solvents such as water, THF, ethanol, and the like. In general, the solvated forms are considered equivalent to the unsolvated forms for the purposes of the present invention.

In a preferred embodiment, the peroxycarboxylic acids, carboxylic acids and/or sulfoperoxycarboxylic acid are provided in an aqueous solution. In a further preferred embodiment, the peroxycarboxylic acids, carboxylic acids and/or sulfoperoxycarboxylic acid are provided in a concentrated solid or aqueous solution.

Exemplary methods and apparatus for making peroxycarboxylic acids are disclosed for example in U.S. Pat. Nos. 7,547,421 and 8,017,082, both entitled “Apparatus and Method for Making a Peroxycarboxylic Acid,” hereby expressly incorporated herein in its entirety by reference. Additional methods and apparatus may be employed and are not intended to limit the scope of the present invention.

Stabilizing Agents

The compositions of the invention include a stabilizing agent. In an aspect, the stabilizing agent is a nitrogen-containing compound, preferably an amine salt, ammonium salt and/or sodium salt, wherein the amine salt and/or a sodium salt are salts of acetic acid and/or sulfuric acid.

In a further aspect the amine is an amine salt. In an aspect, the amine salt is a salt of acetic acid and/or sulfuric acid. Preferred amine salts according to the invention include, for example, alkanolamines, including ethanolamines, such as triethanolamine, diethanolamine and monoethanolamine.

In additional aspects the stabilizing agent is an ammonium salt, including for example, ammonium acetate or ammonium sulfate.

In still further aspects the stabilizing agent is a sodium salt, including for example, sodium acetate or sodium sulfate. In an aspect, the sodium salt is a salt of acetic acid and/or sulfuric acid.

Without being limited to a particular theory of the invention, the stabilizing agents preferably include ammonium, polyethyleneimine, and amine acid salts and/or sodium salts of acetic acid and/or sulfuric acid, as opposed to quaternary ammonium compounds. Amine acid salts are distinct from quaternary ammonium compounds in that at least one hydrogen is bonded to the amine acid salt's nitrogen. In contrast a quaternary ammonium compound has four carbons bonded to it. In addition, ammonium salts are distinct from either of the amine acid salts or quaternary ammonium compounds in that there are four hydrogens bonds to the nitrogen of the ammonium salt. The anions in the amine acid salts and ammonium salts are non-halide anions, including for example, sulfate, bisulfate, benzoate, acetate, formate, propionate, butanoate, phosphate, carbonate, bicarbonate, gluconate, laurate, etc. Preferably the anions are not from chelating acids such as gluconic acid for example. In a preferred aspect of the invention, the anions in the amine acid salt stabilizing agents are not from surface active acids such as, for example, lauric acid. Preferably, the anions in the amine acid salt stabilizing agents are from low molecular weight carboxylic acids, including for example, acetate, formate, propionate, and butanoate. In an aspect, low molecular weight carboxylic acids have a molecular weight less than about 200.

In a preferred embodiment of the invention, the amine salt is formed from an amine and an acid prior to its addition to the peracid composition.

In an aspect of the invention, the stabilizing agent is an ammonium salt, such as ammonium carbonate or bicarbonate, ammonium sulfate and/or ammonium acetate. As one of skill in the art appreciates, urea slowly degrades into the compounds ammonium carbonate or bicarbonate. In a preferred aspect, the stabilizing agent is at least one of an ammonium salt, sodium salt and/or amine salt of acetic acid and/or sulfuric acid.

In an aspect, the stabilizing agent may include polymeric amines, such as polyethyleneimines (PEI), including those disclosed in the related U.S. patent application Ser. No. ______ (Attorney Docket Number 3028US01), entitled Amine Salt Activation of Peroxycarboxylic Acids, which is herein incorporated by reference in its entirety.

The stabilizing agents suitable for use according to the invention provide a shelf-stability of at least about 30 days, preferably at least about 3 months, more preferably at least about 1 year, at least 2 years, or more. In a further aspect, the shelf-stability of the peroxycarboxylic acid compositions is a result of the decrease in hydrogen peroxide and/or peracid decomposition. In an aspect, the shelf-stable compositions have less than about 10% hydrogen peroxide and/or peracid decomposition for at least about 30 days, preferably at least about 3 months, more preferably at least about 1 year, or more. In a preferred aspect, the shelf-stable compositions have less than about 5% hydrogen peroxide and/or peracid decomposition, preferably less than about 1% decomposition, and still more preferably substantially no or no decomposition for the same periods of time.

The stabilizing agents for use according to the invention provide improved stabilization to peroxycarboxylic acid compositions employing a metal chelant and/or sequestrant (e.g. phosphonate) alone. In some embodiments, the use of stabilizing agents according to the invention provides improved stabilization to peroxycarboxylic acid compositions employing only a metal chelant and/or sequestrant (e.g. phosphonate) and the stabilizing agent. In some embodiments, the use of stabilizing agents according to the invention provides synergistic stabilization to peroxycarboxylic acid compositions employing both a metal chelant and/or sequestrant (e.g. phosphonate) and the stabilizing agent. In still further embodiments, the use of a stabilizing agent according to the invention may provide suitable stabilization to replace a conventional metal chelant and/or sequestrant in a peroxycarboxylic acid composition.

In certain aspects of the invention, the shelf-stability provided by the stabilizing agent provides at least the same or substantially similar (e.g. within about 10%, preferably within about 5% of the decomposition of hydrogen peroxide and/or peracid decomposition) stability as a composition employing a conventional metal chelant and/or sequestrant. In additional aspects of the invention, the shelf-stability provided by the stabilizing agent is at least additive and/or synergistic to the stability provided by a metal chelant and/or sequestrant (e.g. phosphonate).

In an aspect, the amine salt and/or sodium salt of acetic acid and/or sulfuric acid, and/or ammonium salt stabilizing agent is not a transition metal chelant and/or sequestrant. In a further aspect, the amine and/or ammonium salt stabilizing agent is not a metal chelant and/or sequestrant. In a further aspect, the stabilizing agent is not an amine oxide. In a further aspect, the stabilizing agent is not a chelant or sequestrating agent of alkylenediamine or its derivatives. In a further optional aspect of the invention, the stabilizing agent is not used in combination with any chelants and/or sequestrants, including in a particular embodiment any phosphonates. In such an optional embodiment of the invention, the stabilizing agent is the sole stabilizer in the peroxycarboxylic acid compositions.

In an aspect, the stabilizing agent may be provided in any form, including a liquid or a solid. In a preferred aspect, the stabilizing agent is provided in a form compatible with a concentrated peracid composition. In embodiments employing a solid stabilizing agent, the solid is diluted for liquid use, which may vary depending upon the preferred methods of improved stabilization according to the invention disclosed herein.

In an aspect, the weight ratio of peracid to stabilizing agent is from about 1000:1 to about 10:1 to provide a peroxycarboxylic acid compositions having enhanced stability and shelf-life. In a preferred aspect of the invention, the weight ratio of peracid to stabilizing agent in a concentrated composition is from about 1000:1 to about 100:1, preferably about 1000:1 to about 500:1, or from about 500:1 to about 100:1 to provide a concentrated peroxycarboxylic acid compositions having enhanced stability and shelf-life. In a still further preferred embodiment the weight ratio of peracid to stabilizing agent in a use solution (i.e. ready to use solution) composition is from about 1000:1 to about 10:1, preferably about 100:1 to about 10:1, or from about 50:1 to about 10:1 to provide a use solution of a peroxycarboxylic acid composition having enhanced stability and shelf-life. As one of skill in the art will ascertain, the weight ratio of stabilizing agent to peracid used to achieve a peroxycarboxylic acid composition having an enhanced shelf-life and stability will vary depending upon the structure of the treated peracid.

In an aspect of the invention, the stabilizing agent is provided in a concentrated peracid composition in amounts from about 1 ppm to 1000 ppm, preferably from 10 ppm to about 500 ppm, preferably from about 10 ppm to about 250 ppm. In additional aspects of the invention, the use of lower concentrations of stabilizing agent provides enhanced stabilization of concentrated peracid compositions, as shown in the Examples of the invention.

Oxidizing Agents

In some aspects of the invention, the peroxycarboxylic acid compositions include at least one oxidizing agent. When present in the peroxycarboxylic acid compositions, any of a variety of oxidizing agents may be employed, for example, hydrogen peroxide. According to an embodiment of the invention, the hydrogen peroxide is also stabilized as a result of the stabilizing agent.

The oxidizing agent can be present at an amount effective to convert a fatty acid, such as a carboxylic acid or a sulfonated carboxylic acid to a peroxycarboxylic acid or a sulfonated peroxycarboxylic acid. In some embodiments, the oxidizing agent can also have antimicrobial activity. In other embodiments, the oxidizing agent is present in an amount insufficient to exhibit antimicrobial activity.

Examples of inorganic oxidizing agents include the following types of compounds or sources of these compounds, or alkali metal salts including these types of compounds, or forming an adduct therewith: hydrogen peroxide, urea-hydrogen peroxide complexes or hydrogen peroxide donors of: group 1 (IA) oxidizing agents, for example lithium peroxide, sodium peroxide; group 2 (IIA) oxidizing agents, for example magnesium peroxide, calcium peroxide, strontium peroxide, barium peroxide; group 12 (IIB) oxidizing agents, for example zinc peroxide; group 13 (IIIA) oxidizing agents, for example boron compounds, such as perborates, for example sodium perborate hexahydrate of the formula Na₂[B₂(O₂)₂(OH)₄]6H₂2O (also called sodium perborate tetrahydrate); sodium peroxyborate tetrahydrate of the formula Na₂B₂(O₂)₂[(OH)₄]4H₂O (also called sodium perborate trihydrate); sodium peroxyborate of the formula Na₂[B₂(O₂)₂(OH).₄] (also called sodium perborate monohydrate); group 14 (IVA) oxidizing agents, for example persilicates and peroxycarbonates, which are also called percarbonates, such as persilicates or peroxycarbonates of alkali metals; group 15 (VA) oxidizing agents, for example peroxynitrous acid and its salts; peroxyphosphoric acids and their salts, for example, perphosphates; group 16 (VIA) oxidizing agents, for example peroxysulfuric acids and their salts, such as peroxymonosulfuric and peroxydisulfuric acids, and their salts, such as persulfates, for example, sodium persulfate; and group VIIa oxidizing agents such as sodium periodate, potassium perchlorate. Other active inorganic oxygen compounds can include transition metal peroxides; and other such peroxygen compounds, and mixtures thereof.

In some embodiments, the compositions of the present invention employ one or more of the inorganic oxidizing agents listed above. Suitable inorganic oxidizing agents include ozone, hydrogen peroxide, hydrogen peroxide adduct, group IIIA oxidizing agent, or hydrogen peroxide donors of group VIA oxidizing agent, group VA oxidizing agent, group VIIA oxidizing agent, or mixtures thereof. Suitable examples of such inorganic oxidizing agents include percarbonate, perborate, persulfate, perphosphate, persilicate, or mixtures thereof.

The peroxycarboxylic acid compositions preferably include a hydrogen peroxide constituent. Beneficially, hydrogen peroxide in combination with the peroxycarboxylic acids provides certain antimicrobial actions against microorganisms. Additionally, hydrogen peroxide can provide an effervescent action which can irrigate any surface to which it is applied. Hydrogen peroxide works with a mechanical flushing action once applied which further cleans the surface. An additional advantage of hydrogen peroxide is the food compatibility of this composition upon use and decomposition. For example, combinations of peroxyacetic acid, peroxyoctanoic acid, and hydrogen peroxide result in acetic acid, octanoic acid, water, and oxygen upon decomposition, all of which are food product compatible and do not adversely affect an apparatus, handling or processing, or other surfaces to which the peroxycarboxylic acid composition is applied.

Surfactants

In some aspects of the invention, the peroxycarboxylic acid compositions also include at least one surfactant. Surfactants may be included in the compositions to enhance microbial efficacy, increase solubility of the peroxycarboxylic acid and/or to maintain the pH of the composition. According to an embodiment of the invention, a surfactant may include a hydrotrope coupler or solubilizer, which can be used to ensure that the composition remains phase stable.

Surfactants suitable for use with the compositions of the present invention are disclosed for example in Kirk-Othmer, Encyclopedia of Chemical Technology, Third Edition, volume 8, pages 900-912, which is herein incorporated by reference in its entirety. Particularly suitable surfactants for use according to embodiments of the invention include, nonionic, anionic, amphoteric, and/or cationic surfactants.

Nonionic Surfactants

Suitable nonionic surfactants suitable for use with the compositions of the present invention include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

Semi-Polar Nonionic Surfactants

The semi-polar type of nonionic surface active agents are another class of nonionic surfactant useful in compositions of the present invention. Semi-polar nonionic surfactants include the amine oxides, phosphine oxides, sulfoxides and their alkoxylated derivatives. In one embodiment of the invention, a surfactant is not an amine oxide.

Amine oxides are tertiary amine oxides corresponding to the general formula:

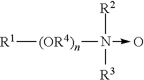

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkylene or a hydroxyalkylene group containing 2 to 3 carbon atoms; and n ranges from 0 to about 20. An amine oxide can be generated from the corresponding amine and an oxidizing agent, such as hydrogen peroxide.

Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Anionic Surfactants

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present compositions also include alkyl sulfonates, the linear and branched primary and secondary alkyl sulfonates, and the aromatic sulfonates with or without substituents.

Anionic carboxylate surfactants suitable for use in the present compositions include carboxylic acids (and salts), such as alkanoic acids (and alkanoates), ester carboxylic acids (e.g. alkyl succinates), ether carboxylic acids, and the like. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

in which R is a C₈ to C₂₂ alkyl group or

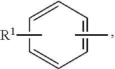

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

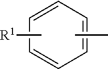

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g. the product Sandopan® DTC, a C₁₃ alkyl polyethoxy (7) carboxylic acid.

Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present invention generally have the general formula:

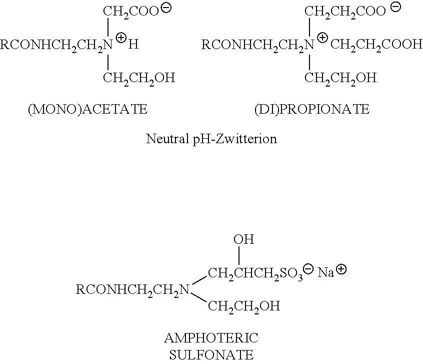

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine Examples of commercial N-alkylamino acid ampholytes having application in this invention include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂—CH₂—CH₂—OH or C₁₂-alkyl-C(O)—N(H)—CH₂—CH₂—N⁺(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch).

Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RnX+Y— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

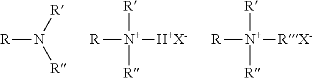

in which, R represents a long alkyl chain, R′, R″, and R′″ may be either long alkyl chains or smaller alkyl or aryl groups or hydrogen and X represents an anion. In some embodiments of the invention, X is not a halide. The amine salts and quaternary ammonium compounds are preferred for practical use in this invention due to their high degree of water solubility.

The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions of the present invention include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

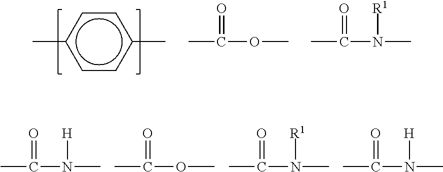

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens. Y is can be a group including, but not limited to:

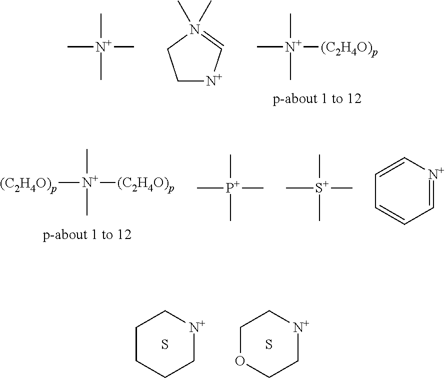

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

Additional Functional Ingredients

In some embodiments, the compositions of the present invention can include additional functional ingredients. Additional functional ingredients suitable for use with the compositions of the present invention include, but are not limited to, acidulants, additional stabilizing agents, e.g., chelating agents, sequestrants and/or crystallization inhibitors, buffers, detergents, wetting agents, defoaming agents, thickeners, foaming agents, hydrogen peroxide reducing agents (e.g. catalase enzymes), solidification agents, threshold agents, aesthetic enhancing agents (i.e., colorants, odorants, or perfumes) and other cleaning agents. These additional ingredients can be preformulated with the compositions of the invention or added to the system before, after, or substantially simultaneously with the addition of the compositions of the present invention.

In an aspect of the invention, the peroxycarboxylic acid compositions do not include a chelating agent and/or sequestrants. In a further optional aspect of the invention, the peroxycarboxylic acid compositions employing the stabilizing agent do not employ any phosphates and/or phosphonates, as a result the compositions are substantially-free of phosphorus (including phosphates and/or phosphonates), and preferably the compositions are free of phosphorus.

In a still further aspect of this invention, the composition includes both a stabilizing agent and a phosphate/phosphonate.

Sequestrants and Chelating Agents

In some embodiments, the peroxycarboxylic acid compositions may include sequestrants and/or chelating agents to further stabilize the compositions. Organic sequestering and chelating agents are particularly suitable for use according to the invention and may include both polymeric and small molecule agents. The polymeric sequestrants commonly include polyanionic compositions, such as polyacrylic acid compounds. According to the invention, polyanionic compounds should not be oxidizable by the peracid or hydrogen peroxide of the compositions.

Organic small molecule agents include organocarboxylate compounds or organophosphate agents. Exemplary small molecule organic agents include ethylenediaminetriacetic acid (EDTA), diethylenetriaminepentaacetic acid (DTPA), N-hydroxyethylenediaminetriacetic acid (HEDTA), nitrilotriaacetic acid (NTA), methylglycinediacetic acid (MGDA), tetrasodium L-glutamic acid, N,N-diacetic acid (GLDA), triethylenetetraaminehexaacetic acid (TTHA), and the respective alkali metal, ammonium and substituted ammonium salts thereof.

Phosphates and aminophosphonates may also be also suitable for use with the compositions, including ethylenediaminetetramethylene phosphonates, nitrilotrismethylene phosphonates, 1-hydroxy ethylidene-1,1-diphosphonates, diethylenetriamine-pentamethylene phosphonate, and 2-phosphonobutane-1,2,4-tricarboxylates, for example. Alternative suitable sequestrants include water soluble polycarboxylate polymers, including homopolymeric and copolymeric agents such as polymeric compositions with pendant (—CO2H) carboxylic acid groups, including polyacrylic acid, polymethacrylic acid, polymaleic acid, acrylic acid-methacrylic acid copolymers, acrylic-maleic copolymers, hydrolyzed polyacrylamide, hydrolyzed methacrylamide, hydrolyzed acrylamide-methacrylamide copolymers, hydrolyzed polyacrylonitrile, hydrolyzed polymethacrylonitrile, hydrolyzed acrylonitrile methacrylonitrile copolymers, or mixtures thereof. Water soluble salts or partial salts of these polymers or copolymers such as their respective alkali metal or ammonium salts may also be used. The weight average molecular weight of the polymers is from about 4,000 to about 12,000. These and other sequestrants and/or chelating agents known in the art may be employed in combination with the stabilizing agents.

Exemplary Compositions

Various embodiments of the invention are shown in Tables 1 and 2 depicting suitable concentrate and ready-to-use, respectively, peroxycarboxylic acid compositions according to the invention.

TABLE 1
(concentrate)

| | Wt-% | Wt-% | Wt-% |
|---|---|---|---|
| Peracid | 0.1-80 | 1-50 | 5-30 |
| Carboxylic Acid | 0.1-80 | 1-50 | 5-30 |
| Stabilizing | 0.001-20 | 0.01-10 | 0.1-10 |
| Agent | | | |
| Oxidizing | 0.1-80 | 1-50 | 5-30 |
| Agent | | | |
| Surfactant | 0-50 | 0-30 | 0-20 |
| Additional | 0-50 | 0-20 | 0-10 |
| Functional | | | |
| Ingredients | | | |
| Water | 0-50 | 0-30 | 0-20 |

TABLE 2
(ready-to-use)

| | Wt-% | Wt-% | Wt-% |
|---|---|---|---|
| Peracid | 0.001-50 | 0.01-40 | 0.1-20 |
| Carboxylic Acid | 0.001-50 | 0.01-40 | 0.1-20 |
| Stabilizing | 0.0001-10 | 0.001-10 | 0.001-5 |
| Agent | | | |
| Oxidizing | 0.001-50 | 0.01-40 | 0.1-20 |
| Agent | | | |
| Surfactant | 0-50 | 0.1-20 | 1-20 |
| Additional | 0-50 | 0.1-20 | 1-10 |
| Functional | | | |
| Ingredients | | | |
| Water | 0-80 | 0-50 | 0-30 |

Beneficially, the peroxycarboxylic acid compositions according to the invention provide at least 30 day stability at high temperatures of about 40° C., and shelf stability of at least about six months, preferably at least one years or more for the compositions of the invention, wherein the stability is represented by the lack of any substantial decomposition of the hydrogen peroxide and/or peracid content of the compositions (i.e. less than 10%), preferably no decomposition of the peracid content of the compositions.

According to the invention, the amount of peroxycarboxylic acid in use and concentrate compositions can range up to the limits at which the peroxycarboxylic acid can be dissolved or suspended in the composition.

The peroxycarboxylic acid compositions include both concentrate compositions and use compositions. For example, a concentrate composition can be diluted, for example with water, to form a use composition. In an embodiment, a concentrate composition can be diluted to a use solution before to application to an object. Primarily for reasons of economics, the concentrate can be marketed and an end user can dilute the concentrate with water or an aqueous diluent to a use solution. According to an aspect of the invention, it is preferred to add the stabilizing agent to the concentrated peroxycarboxylic acid. However, as one skilled in the art will ascertain, the stabilizing agent can also be introduced into a use solution formed by diluting a concentrated peroxycarboxylic acid composition.

The level of active components (and percent actives) in the concentrate composition is dependent on the intended dilution factor and the desired activity of the sulfonated peroxycarboxylic acid compound. Generally, a dilution of about 1 fluid ounce to about 10 gallons of water to about 10 fluid ounces to about 1 gallon of water is used for aqueous compositions of the present invention. In some embodiments, higher use dilutions can be employed if elevated use temperature or extended exposure time (greater than 30 seconds) can be employed. In the typical use locus, the concentrate is diluted with a major proportion of water using commonly available tap or service water mixing the materials at a dilution ratio of about 3 to about 40 ounces of concentrate per 100 gallons of water.

In some embodiments, such as use in laundry applications, the concentrated compositions can be diluted at a dilution ratio of about 0.1 g/L to about 100 g/L concentrate to diluent, about 0.5 g/L to about 10.0 g/L concentrate to diluent, about 1.0 g/L to about 4.0 g/L concentrate to diluent, or about 1.0 g/L to about 2.0 g/L concentrate to diluent. In other embodiments, a use composition can include about 0.01 to about 10 wt-% of a concentrate composition and about 90 to about 99.99 wt-% diluent; or about 0.1 to about 1 wt-% of a concentrate composition and about 99 to about 99.9 wt-% diluent. Amounts of an ingredient in a use composition can be calculated from the amounts listed above for concentrate compositions and these dilution factors.

As one skilled in the art shall appreciate based on the disclosure of the present invention, the enhanced stability antimicrobial and/or bleaching compositions of the invention can be formulated as a liquid concentrate composition and/or use compositions. The peracid compositions of the present invention can also be formulated as a gel, an aerosol, a gas, a wax, a solid, or a powder, or as a solution or suspension containing such a composition.

Each of the compositions can be formulated by combining the various ingredients. The peroxycarboxylic acid compositions are formulated to provide an equilibrium composition, wherein the peracid exists in equilibrium with its corresponding carboxylic acid and hydrogen peroxide (or other oxidizing agent).

In an aspect of the invention, the peroxycarboxylic acid compositions have improved stability over conventional, commercially-available peroxycarboxylic acid compositions. In a further aspect, the peroxycarboxylic acid compositions have improved stability over peroxycarboxylic acid compositions formulated with a chelant and/or stabilizing agent (including for example phosphonates). In some embodiments, the compositions of the present invention are stable for at least about 2 years at room temperature. In further embodiments, the compositions of the present invention are stable for at least about 1 year at room temperature.

In an aspect, the treated peroxycarboxylic acid compositions employing the stabilizing agent do not have a significantly altered pH from the original peracid composition. Typically, the pH of an equilibrium peracid mixture is less than about 1 or about 2, and wherein the pH of a 1% solution of the equilibrium mixture in water is about 2 to about 9, depending on the other components of the 1% solution, and the pH of a use composition can be from about 1 to about 9 depending on the other components. Preferably, compositions according to the invention have a pH less than about 7, or from about 1 to 7. It is to be understood that all ranges and values between these ranges and values are encompassed by the present invention.

Methods of Enhancing Stability and Shelf-Life

Peroxycarboxylic acid compositions are generated having significantly enhanced stability and increased shelf-life according to the compositions and methods of the invention. The methods of enhancing stability and increasing shelf-life of peroxycarboxylic acid compositions may comprise, consist of and/or consist essentially of providing a peracid to be treated and contacting the peracid with a stabilizing agent according to the compositions of the invention. The methods may optionally further comprise, consist of and/or consist essentially of adding an conventional stabilizing sequestrant and/or chelant. In an alternative embodiment, the stabilizing sequestrant and/or chelant (e.g. organophosphonate) may be incorporated into a commercial peroxycarboxylic acid for use according to the invention. In such an embodiment, the stabilizing agent(s) according to the invention may be combined therewith to provide still further unexpected improvements in peroxycarboxylic acid stability.

In a preferred aspect, a peracid is contacted with at least one stabilizing agent selected from the group consisting of an amine acid salt and/or a sodium salt of acetic acid and/or sulfuric acid, an ammonium salt, a polymeric amine salt, and combinations of the same.

The contacting of the peracid with the stabilizing agent may occur through the direct application of the stabilizing agent to a peracid composition, including for example, dissolving the stabilizing agent into the peracid. In an alternative, the contacting of the peracid with the stabilizing agent may occur at a point of use by mixing or co-dispensing the peracid and the stabilizing agent.

According to the invention, the methods of enhancing stability and increasing shelf-life of a peracid composition do not significantly alter the pH of the treated peroxycarboxylic acid composition. In an aspect, the pH of the treated peroxycarboxylic acid compositions are less than about 9, preferably from about 1 to about 9, preferably from about 1 to about 5. The preferred pH ranges of the treated peroxycarboxylic acid compositions undergo a pH change of less than about 1 pH unit, preferably less than about 0.5 pH units according to the methods of the invention.

The methods of the invention are suitable for use according to a broad temperature range. Beneficially, the step of contacting the peracid with the stabilizing agent may occur at a temperature range from about 10 to 70° C., preferably about 20 to 60° C.

Methods of Using Reduced Odor Peroxycarboxylic Acid Compositions

According to one embodiment of the invention, the peroxycarboxylic acid compositions are employed for antimicrobial or bleaching activity of the peracid of the compositions. The compositions of the present invention can be used as antimicrobial or bleaching compositions for a variety of substrates and surfaces, e.g., textiles and hard surfaces. The compositions of the present invention can also be used as antimicrobial, disinfectant and/or sanitizer compositions. Preferably the compositions are particularly suitable for use at acid or neutral pHs. According to the invention, the methods of using the compositions employ compositions having a pH from about 1 to about 9, preferably from about 1 to about 5.

The compositions may be used for various applications, e.g., food contact sanitizing, hard surface disinfection, including large architectural surfaces, plant sanitizing, and textile disinfection, including laundry detergent and/or bleaching, souring and/or sanitizing. In some embodiments, compositions containing compounds of the present invention can be multipurpose. That is, the compositions of the present invention can, for example, act as both antimicrobials and bleaches. The compositions of the present invention can further act as disinfection, a combination of disinfection and cleaning, virucidal treatment and/or fungicidal treatment.

According to an embodiment of the invention, a method for reducing a microbial population on a variety of surfaces, a method for reducing an odor, and a method for bleaching a variety of surfaces are provided. The methods according to the invention can operate on an object, article, surface, or the like, by contacting the object, article or surface with a peroxycarboxylic acid composition of the invention. As one skilled in the art shall ascertain based upon the disclosure of the present invention, contacting can include any of numerous methods for applying a composition, such as spraying the composition, immersing the object in the composition, foam or gel treating the object with the composition, or a combination thereof.

The peroxycarboxylic acid compositions of the invention can be used for a variety of domestic or industrial applications. In an embodiment, the peroxycarboxylic acid compositions can be used at manufacturing or processing sites handling foods and plant species. In further embodiments the compositions can be employed for cleaning or sanitizing food processing equipment or materials; sanitizing food contact and nonfood contact hard surfaces, including as a delivery agent of available oxygen; aseptic and ESL bottle rinse applications; conveyor treatments; foam sanitizing for nonfood contact surfaces; fogging sanitization for rooms; nonfood contact packaging equipment; bacteriophage control when applied to pre-cleaned surfaces; sterilization of manufacturing, filling, and packaging equipment in aseptic processes; disinfecting pharmaceutical and cosmetic surfaces; poultry house disinfection; farm premise disinfection; antimicrobial treatment of water filters, reverse osmosis (RO) and ultra-filtration (UF) membrane systems; boosters for alkaline detergents to clean food processing equipment; boosters for acid detergents to clean food processing equipment; sanitizing of hatching eggs, coops, trucks, crates (poultry); food storage facilities; anti-spoilage air circulation systems; refrigeration and cooler equipment; beverage chillers and warmers, blanchers, cutting boards, third sink areas, and meat chillers or scalding devices; and the like.

In some aspects, the peroxycarboxylic acid compositions are useful in the cleaning or sanitizing of containers, processing facilities, or equipment in the food service or food processing industries. The compounds and compositions have particular value for use on food packaging materials and equipment, and especially for cold or hot aseptic packaging. Examples of process facilities in which the compound of the invention can be employed include a milk line dairy, a continuous brewing system, food processing lines such as pumpable food systems and beverage lines, etc. Food service wares can be disinfected with the compound of the invention. For example, the compounds can also be used on or in ware wash machines, low temperature ware wash machines, dishware, bottle washers, bottle chillers, warmers, third sink washers, cutting areas (e.g., water knives, slicers, cutters and saws) and egg washers. Particular treatable surfaces include packaging such as cartons, bottles, films and resins; dish ware such as glasses, plates, utensils, pots and pans; ware wash and low temperature ware wash machines; exposed food preparation area surfaces such as sinks, counters, tables, floors and walls; processing equipment such as tanks, vats, lines, pumps and hoses (e.g., dairy processing equipment for processing milk, cheese, ice cream and other dairy products); and transportation vehicles. Containers include glass bottles, PVC or polyolefin film sacks, cans, polyester, PEN or PET bottles of various volumes (100 ml to 2 liter, etc.), one gallon milk containers, paper board juice or milk containers, etc.

In a further embodiment, the peroxycarboxylic acid compositions can be employed in a variety of health care, laundry care and/or vehicle care environments. Still further, embodiments for use of the peroxycarboxylic acid compositions include disinfection applications, biofilm reduction and the treatment of waste water where both its antimicrobial function and its oxidant properties can be utilized.

The present peroxycarboxylic acid compositions can be employed for reducing the population of pathogenic microorganisms, such as pathogens of humans, animals, and the like. The peroxycarboxylic acid compositions have activity against a variety of pathogens, including Gram positive (for example, Listeria monocytogenes or Staphylococcus aureus) and Gram negative (for example, Escherichia coli or Pseudomonas aeruginosa) bacteria, yeast, molds, bacterial spores, viruses, etc. fungi, molds, bacteria, spores (e.g. endospores), and viruses. Such pathogens can cause a variety of diseases and disorders. As a result of the activity of the peroxycarboxylic acid compositions, they can be used as or included in products such as sterilants, sanitizers, disinfectants, preservatives, deodorizers, antiseptics, fungicides, germicides, sporicides, virucides, detergents, bleaches, hard surface cleaners, and pre- or post-surgical scrubs.

According to an embodiment of the invention, the peroxycarboxylic acid compositions are utilized to kill one or more of the food-borne pathogenic bacteria associated with a food product, including, but not limited to, Salmonella, Campylobacter, Listeria, Escherichia coli, yeast, and mold. According to further embodiments, the peroxycarboxylic acid compositions are utilized to kill one or more of the pathogenic bacteria associated with a health care surfaces and environments including, but not limited to, Salmonella, Staphylococcus, including methicillin resistant Staphylococcus aureus, Salmonella, Pseudomonas, Escherichia, mycobacteria, yeast, and mold. In still further embodiments, the peroxycarboxylic acid compositions can kill a wide variety of microorganisms on a food processing surface, on the surface of a food product, in water used for washing or processing of food product, on a health care surface, or in a health care environment.

A concentrate or use concentration of the peroxycarboxylic acid compositions can be applied to or brought into contact with an object or surface by any conventional method or apparatus for applying an antimicrobial or composition to an object or surface. For example, the object can be wiped with, sprayed with, and/or immersed in the peracid composition, or a use composition made from the peracid composition. Contacting can be manual or by machine which may employ a liquid, gel, aerosol, gas, wax, solid, or powdered peracid compositions according to the invention, or solutions containing these compositions.

According to an embodiment of the invention, upon application of the peroxycarboxylic acid compositions the object, article or surface may be moved with mechanical action, preferably agitated, rubbed, brushed, etc. Agitation can be by physical scrubbing, through the action of the spray solution under pressure, through sonication, or by other methods. Agitation increases the efficacy of the spray solution in killing micro-organisms, perhaps due to better exposure of the solution into the crevasses or small colonies containing the micro-organisms. According to further embodiments of the invention a use solution of the peroxycarboxylic acid composition can also be used at a temperature of about 10 to 70° C., preferably about 20 to 60° C. to increase efficacy.

A sprayed peroxycarboxylic acid composition can be left on a treated object or surface for a sufficient amount of time to suitably reduce the population of microorganisms, and then rinsed, drained and/or evaporated off the treated object or surface. The present methods require a certain minimal contact time of the peracid composition for occurrence of significant antimicrobial effect. The contact time can vary with concentration of the use composition, method of applying the use composition, temperature of the use composition, amount of soil on the treated object or surface, number of microorganisms on the treated object or surface, type of antimicrobial agent, or the like. Preferably the exposure time is at least about 5 to about 15 seconds.

Immersing an object or surface in a liquid peroxycarboxylic acid composition can be accomplished by any of a variety of methods known to those of skill in the art. For example, the object can be placed into a tank or bath containing the peroxycarboxylic acid composition. Alternatively, the object can be transported or processed in a flume of the peroxycarboxylic acid composition. The washing solution is preferably agitated to increase the efficacy of the solution and the speed at which the solution reduces micro-organisms accompanying the object. Agitation can be obtained by conventional methods, including ultrasonics, aeration by bubbling air through the solution, by mechanical methods, such as strainers, paddles, brushes, pump driven liquid jets, or by combinations of these methods. The washing solution can be heated to increase the efficacy of the solution in killing micro-organisms. After the object has been immersed for a time sufficient for the desired antimicrobial effect, the object can be removed from the bath or flume and the peracid composition can be rinsed, drained, or evaporated off the object.

Methods for Industrial Processing

In some aspects, the invention includes methods of using the peroxycarboxylic acid compositions to prevent biological fouling in various industrial processes and industries, including oil and gas operations, to control microorganism growth, eliminate microbial contamination, limit or prevent biological fouling in liquid systems, process waters or on the surfaces of equipment that come in contact with such liquid systems. As referred to herein, microbial contamination can occur in various industrial liquid systems including, but not limited to, air-borne contamination, water make-up, process leaks and improperly cleaned equipment. In another aspect, the peroxycarboxylic acid compositions are used to control the growth of microorganisms in water used in various oil and gas operations. In a further aspect, the compositions are suitable for incorporating into fracturing fluids to control or eliminate microorganisms.

For the various industrial processes disclosed herein, “liquid system” refers to flood waters or an environment within at least one artificial artifact, containing a substantial amount of liquid that is capable of undergoing biological fouling, it includes but is not limited to industrial liquid systems, industrial water systems, liquid process streams, industrial liquid process streams, industrial process water systems, process water applications, process waters, utility waters, water used in manufacturing, water used in industrial services, aqueous liquid streams, liquid streams containing two or more liquid phases, and any combination thereof.

In at least one embodiment this technology would be applicable to any process or utility liquid system where microorganisms are known to grow and are an issue, and biocides are added. Examples of some industrial process water systems where the method of this invention could be applied are in process water applications (flume water, shower water, washers, thermal processing waters, brewing, fermentation, CIP (clean in place), hard surface sanitization, etc.), Ethanol/Bio-fuels process waters, pretreatment and utility waters (membrane systems, ion-exchange beds), water used in the process/manufacture of paper, ceiling tiles, fiber board, microelectronics, E-coat or electro deposition applications, process cleaning, oil exploration and energy services (completion and work over fluids, drilling additive fluids, fracturing fluids, flood waters, etc.; oil fields—oil and gas wells/flow line, water systems, gas systems, etc.), and in particular water systems where the installed process equipment exhibits lowered compatibility to halogenated biocides.

Those skilled in the art will recognize, or be able to ascertain using no more than routine experimentation, numerous equivalents to the specific procedures, embodiments, claims, and examples described herein. Such equivalents are considered to be within the scope of this invention and covered by the claims appended hereto. The contents of all references, patents, and patent applications cited throughout this application are hereby incorporated by reference to the same extent as if each individual publication or patent application was specifically and individually indicated as incorporated by reference. All publications and patent applications in this specification are indicative of the level of ordinary skill in the art to which this invention pertains. The invention is further illustrated by the following examples, which should not be construed as further limiting.

All publications and patent applications in this specification are indicative of the level of ordinary skill in the art to which this invention pertains. All publications and patent applications are herein incorporated by reference to the same extent as if each individual publication or patent application was specifically and individually indicated as incorporated by reference.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

The materials used in the following Examples are provided herein:

Oxonia Active®: a peroxyacetic acid antimicrobial agent (5.8% peroxyacetic acid, 27.5% hydrogen peroxide), available from Ecolab Inc.

Candidate stabilizing agents: ammonium acetate; ethylene diamine diacetate; monoethanolamine; diethanolamine; triethanolamine; polyethyleneimine derivatized with ethylenediamine, molecular weight 800 available from Aldrich Chemical.

### Example 1

The stability of the compositions of the present invention was evaluated to determine preferred stabilizing agents. Table 3 shows various candidate stabilizing agents analyzed to determine the effect on reducing decomposition and improving shelf-stability of peracid compositions. The various stabilizing agents were added to commercially-available concentrated peroxyacetic acid compositions. Various compositions were pre-neutralized with acetic acid (*).

Initially the candidate stabilizing agents shown in Table 3 were prepared as samples containing 500 ppm additive. An initial screening analysis showed increased stability for all additives (excluding ammonium sulfate). Thereafter, the peracid compositions with the candidate stabilizing agents were formulated into peracid compositions using Oxonia Active® according to the formulas shown in Table 3.

TABLE 3

| | Mass of | Mass of | Mass of | |
|---|---|---|---|---|
| | Oxonia | Additive | Glacial Acetic | Stability |
| Additive | Added | Added | Acid Added | Enhanced |
| Ammonium Acetate | 50.1 | 3.06 | 0 | Yes |
| Ethylene Diamine | 50.05 | 1.43 | 3.01 | Yes |
| Diacetate* | | | | |
| Polyethyleneimine | 50.02 | 2.05 | 4.02 | Yes |
| Ethylenediamine | | | | |
| End-Capped* | | | | |
| Triethanolamine* | 50 | 5.94 | 10.09 | Yes |
| Diethanolamine* | 50.03 | 4.19 | 10.37 | Yes |
| Ethanolamine* | 50.13 | 2.43 | 5.03 | Yes |
| Ammonium Sulfate | 49.99 | 5.27 | 0 | Yes/Slight |
| Sodium Sulfate | 50.01 | 5.61 | 0 | Yes |
| Sodium Acetate | 50.32 | 5.46 | 0 | Yes |
| (Trihydrate) | | | | |
| Control | 61.46 | None | 0 | No |

Thirty day stability in an oven at about 40° C. was evaluated, to represent one year shelf stability (e.g. room temperature) of a composition. To find the concentrations, the samples were titrated every 7 days for 28 days with 0.1N Ceric Sulfate to find the hydrogen peroxide content and 0.1N Sodium Thiosulfate to find the POAA content. In between titrations the samples were kept in an about 40° C. oven.

As shown in Table 3, various additives in varying weight ranges provide enhancements in the peracid composition stability. The stability enhancements achieved at elevated temperatures (40° C.) provide an accelerated mechanism of assessing stability data at lower temperatures (including room temperature) for extended periods of time. For example the month stability testing conducted at elevated temperatures (40° C.) is indicative of long term stability, such as one year stability at room temperature.

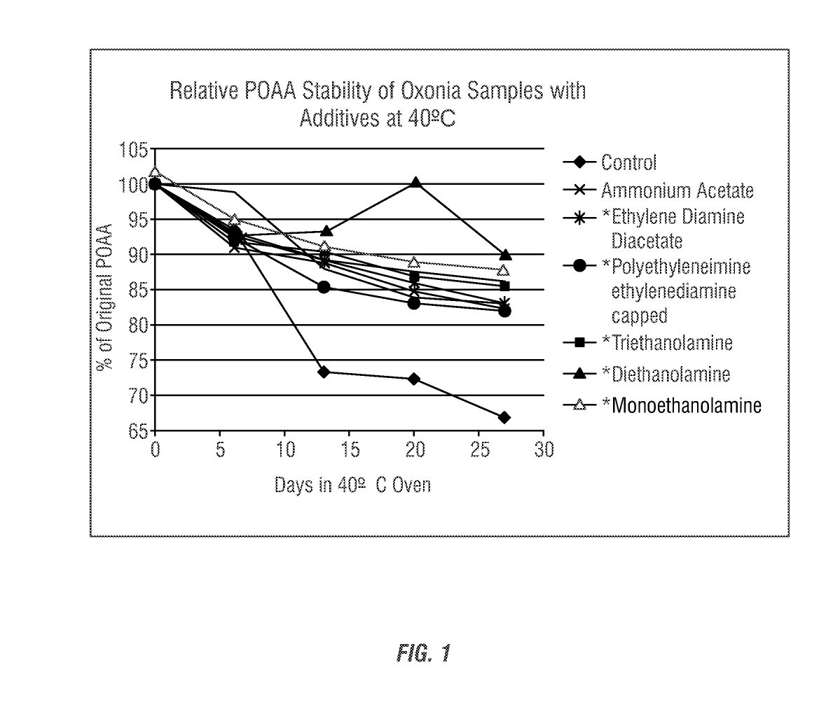

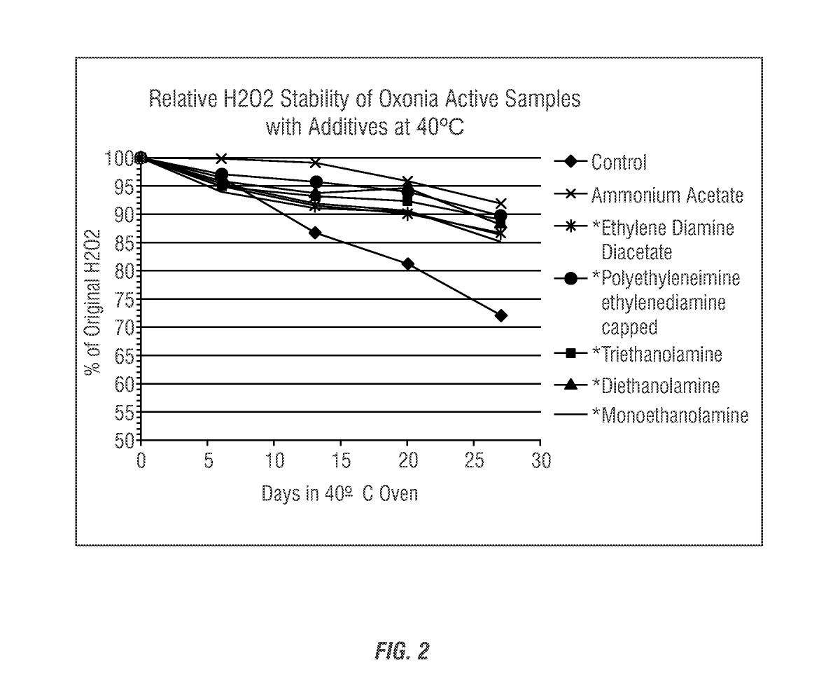

As shown in FIGS. 1 and 2, both the peracetic acid (FIG. 1) and the hydrogen peroxide (FIG. 2) in the concentrated peroxyacetic acid compositions were stabilized by the addition of the various ammonium salts, amine salts, and polymeric amines. The control shown in the figures represents the stability of the commercially-available concentrated peracid composition Oxonia Active® alone.

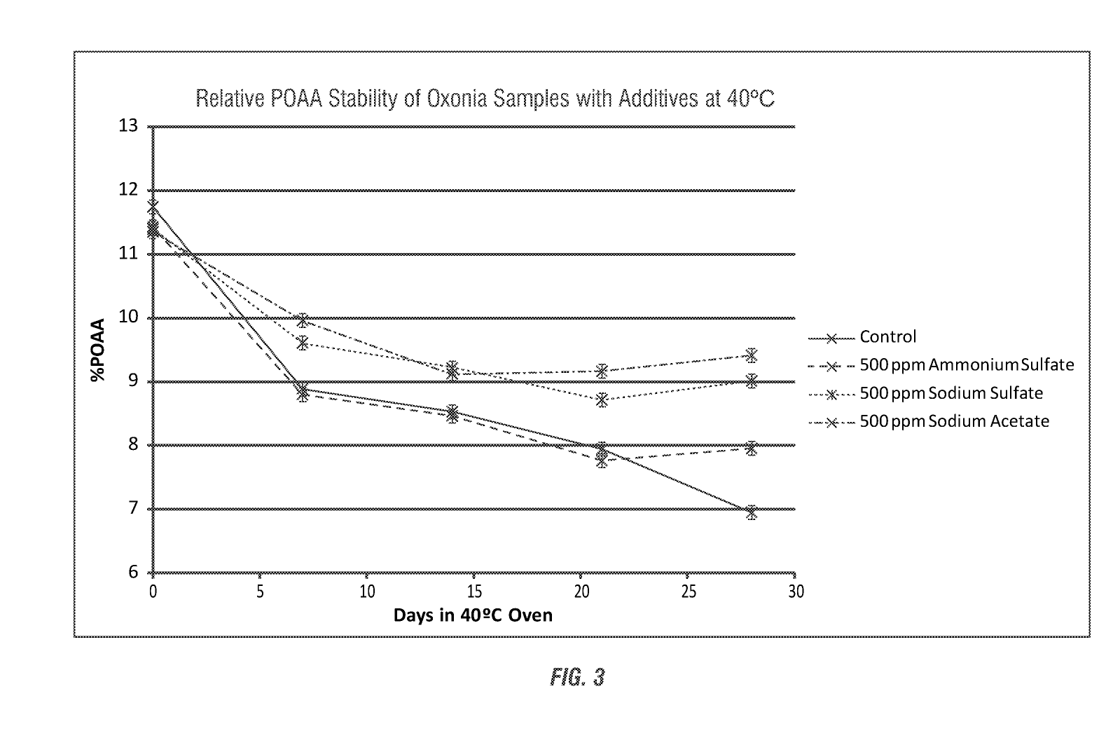

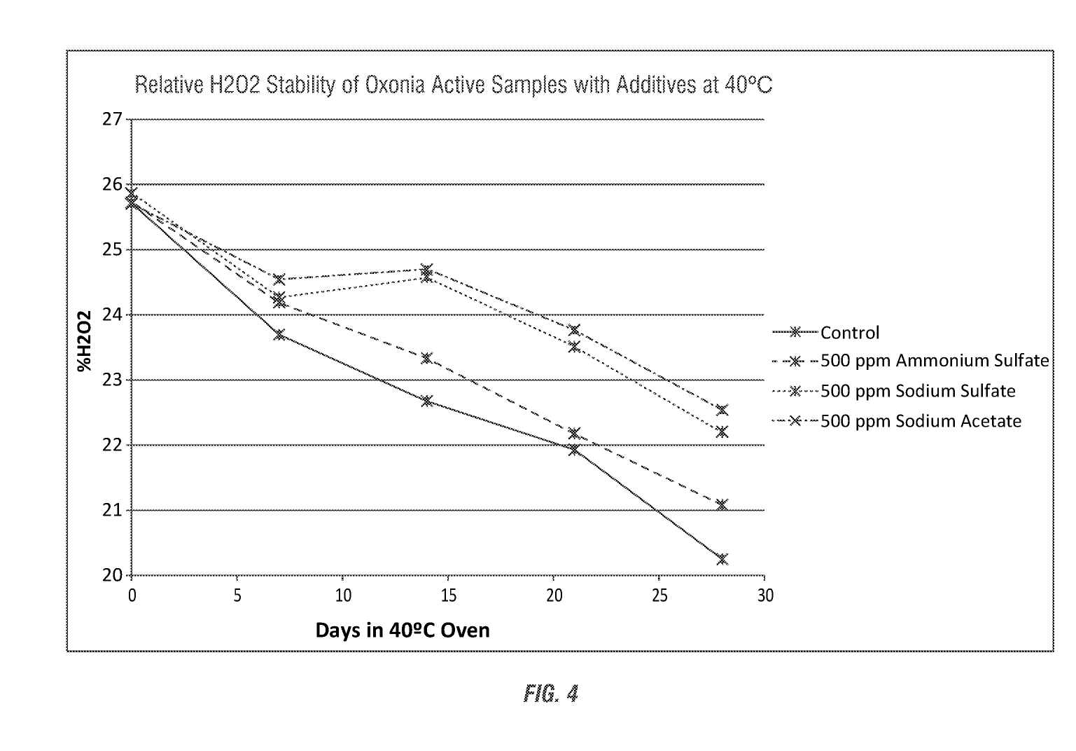

As shown in FIGS. 3 and 4, both the peracetic acid (FIG. 3) and the hydrogen peroxide (FIG. 4) in the concentrated peroxyacetic acid compositions were stabilized by the addition of ammonium salt and the sodium salts. The control shown in the figures represents the stability of the commercially-available concentrated peracid composition Oxonia Active® alone.

### Example 2

The individual additives (e.g. candidate stabilizing agents) were further analyzed to determine the concentration effects on stability of the Oxonia Active® peracid compositions. Unexpectedly, it has been determined using formulations of various candidate stabilizing agents (TEA-Acetate (TEA neutralized with glacial acetic acid), Ammonium Sulfate, and TEA-Acetate w/ Ammonium sulfate (equal weights of both)) at concentrations of 5 wt-%, 1 wt-% 0.5 wt-%, 1000 ppm, 500 ppm, and 250 ppm, result in decreased stability compared to controls at high concentrations of additives. However, beneficial improvements in stability are achieved at lower concentrations of additives.

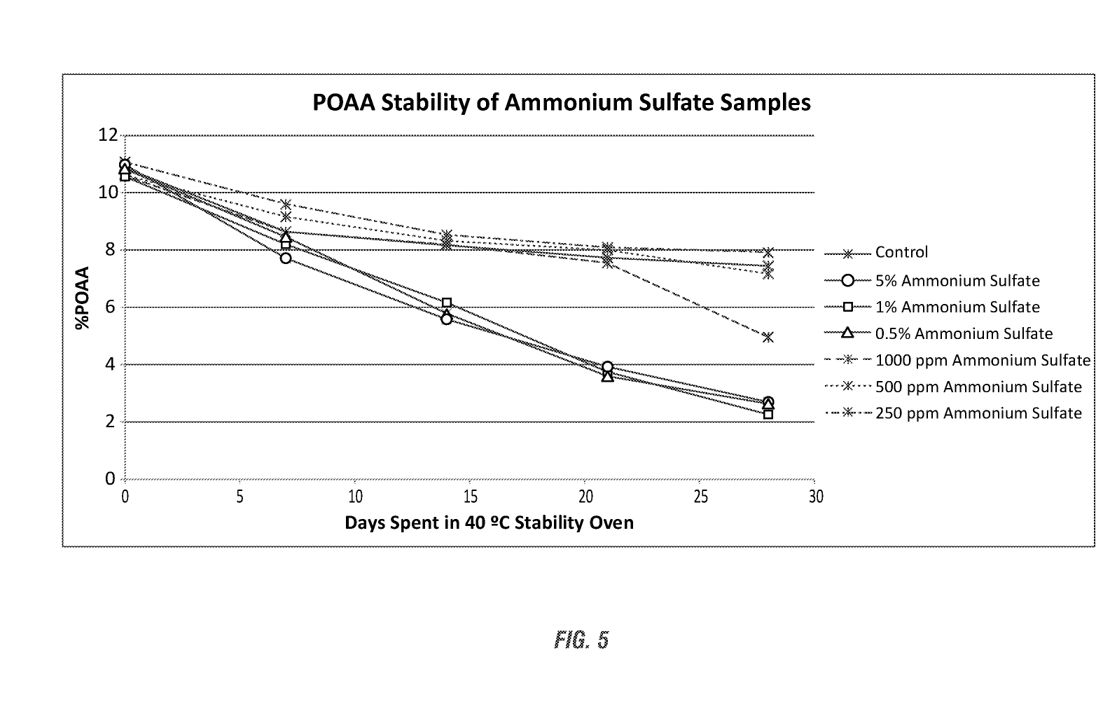

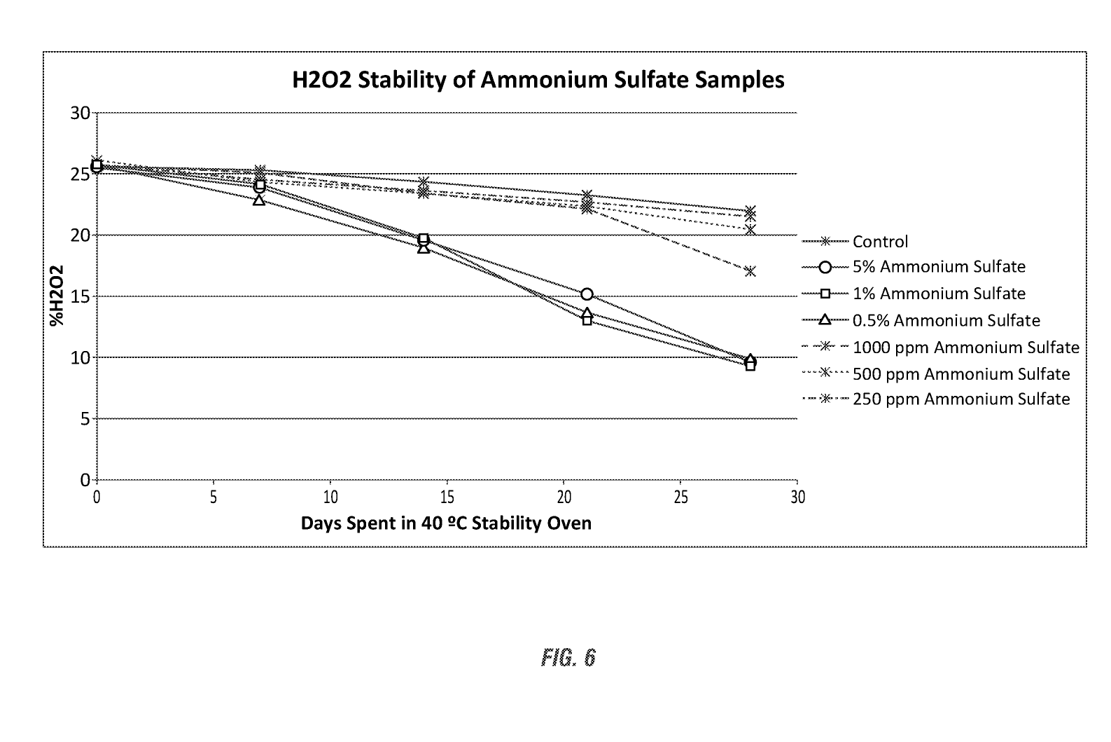

As shown in FIGS. 5 and 6 the use of the various ammonium salt stabilizing agents also provide improved stabilization benefits for the peracid concentration and hydrogen peroxide concentration at lower concentration levels when used with the concentrated Oxonia Active®. FIG. 5 shows the stabilizing effect on peracid concentration. FIG. 6 shows the stabilizing effect on hydrogen peroxide concentration. FIG. 5 shows the use of various ammonium salts at varying concentrations with the concentrated peracid composition, demonstrating that at the 4 week period (end of testing), the use of 250 ppm ammonium sulfate exceeds the peracid stability of the control (unstabilized Oxonia Active®).

The inventions being thus described, it will be obvious that the same may be varied in many ways. Such variations are not to be regarded as a departure from the spirit and scope of the inventions and all such modifications are intended to be included within the scope of the following claims.

What is claimed is:

1. An enhanced stability peroxycarboxylic acid composition comprising:
at least one peroxycarboxylic acid;
hydrogen peroxide; and
a stabilizing agent, wherein the stabilizing agent is a nitrogen-containing compound or sodium salt that is effective for enhancing peroxycarboxylic acid stability and is present in a weight ratio of peroxycarboxylic acid to stabilizing agent from about 1000:1 to about 10:1.

2. The composition of claim 1, wherein the stabilizing agent is an amine salt of acetic acid and/or sulfuric acid, an ammonium salt, a polymeric amine, or a sodium salt of acetic acid and/or sulfuric acid.

3. The composition of claim 2, wherein the amine salt is the acid salt of an alkanolamine.

4. The composition of claim 2, wherein the anions in the amine acid salt or ammonium salt are non-halide anions.

5. The composition of claim 1, wherein the stabilizing agent is not a quaternary ammonium compound or amine oxide.

6. The composition of claim 1, wherein the at least one peroxycarboxylic acid is an alkyl peroxycarboxylic acid.

7. The composition of claim 1, wherein at least one peroxycarboxylic acid is a C1-C20 alkyl peroxycarboxylic acid.

8. The composition of claim 1, wherein less than about 10% decomposition of the hydrogen peroxide and peroxycarboxylic acid occurs over a period of at least one year.

9. The composition of claim 1, further comprising a transition metal chelant and/or sequestrant.

10. The composition of claim 1, further comprising an additional oxidizing agent, at least one carboxylic acid, surfactant, water and/or additional functional ingredients.

11. A stability enhanced peroxycarboxylic acid composition comprising:
about 0.01 wt-% to 50 wt-% of at least one peroxycarboxylic acid selected from the group consisting of an alkyl peroxycarboxylic acid, a sulfoperoxycarboxylic acid and combinations of the same;
about 0.01 wt-% to 50 wt-% of hydrogen peroxide; and
about 0.00001 wt-% to 10 wt-% of a stabilizing agent, wherein the stabilizing agent is a nitrogen-containing compound or a sodium salt that is effective for enhancing peroxycarboxylic acid and hydrogen peroxide stability and is present in a weight ratio of peroxycarboxylic acid to stabilizing agent from about 1000:1 to about 10:1, and wherein less than about 10% decomposition of the hydrogen peroxide and peroxycarboxylic acid occurs over a period of at least one year.

12. The composition of claim 11, wherein the stabilizing agent is an amine salt of acetic acid and/or sulfuric acid, an ammonium salt, a polymeric amine, or a sodium salt of acetic acid and/or sulfuric acid, and wherein the peroxycarboxylic acid is an alkyl peroxycarboxylic acid.

13. The composition of claim 11, wherein a ready to use composition comprises from about 0.01 wt % to 20 wt-% peroxycarboxylic acid and from about 0.001 wt-% to 5 wt-% stabilizing agent.

14. The composition of claim 11, wherein a concentration composition comprises from about 1 wt-% to 50 wt-% peroxycarboxylic acid and from about 0.01 wt-% to 10 wt-% stabilizing agent.

15. The composition of claim 11, further comprising water, at least one carboxylic acid and an oxidizing agent comprising hydrogen peroxide.

16. The composition of claim 11, further comprising a surfactant, water, additional functional ingredient, a chelant and/or a sequestrant.

17. A method of reducing population of microorganism on an object, comprising: contacting an object with a stability enhanced peroxycarboxylic acid composition of claim 11.

18. The method of claim 17, wherein the object is a food processing or manufacturing surface, food tissue, food packaging, a health care surface, medical or surgical devices, textiles, a body or stream of water, a body or stream of gas, a hospitality sector surface, an industrial sector surface, an agricultural surface, a veterinary surface, architectural surfaces, dishware, hard surface packaging, or a combination thereof.

19. The method of claim 17, further comprising a first step of contacting a peracid composition with a stabilizing agent to form the peroxycarboxylic acid composition.

20. The method of claim 17, wherein the peroxycarboxylic acid composition is present in an amount effective for reducing a population of a microorganism selected from the group consisting of spores, bacteria, mold, yeast, viruses and mixtures thereof.
